(19) United States
(12) Patent Application Publication
(10) Pub. No.: US 2017/0270255 A1
(43) Pub. Date: Sep. 21, 2017

(54) Pre-Purchase Order Auditing Systems and Methods for Health Care

(71) Applicant: Clinical Orthopedic Resources, LLC, Houston, TX (US)

(72) Inventor: Brian Domingues, Houston, TX (US)

(21) Appl. No.: 15/070,563

(22) Filed: Mar. 15, 2016

(51) Int. Cl. G06F 19/00; G06Q 30/06

(52) U.S. Cl. CPC G06F 19/328; G06Q 30/0633

(57) ABSTRACT

Systems and methods for auditing proposed healthcare purchases are described. An example method for auditing proposed healthcare purchases includes the steps of obtaining from a first source a procedure identifier for a proposed healthcare procedure and obtaining from a second source a proposed procedure product inventory. It also includes the steps of inputting the procedure identifier into a computer, retrieving from a data store operably connected to the computer an approved procedure product inventory of one or more items for the proposed healthcare procedure represented by the procedure identifier, comparing the proposed procedure product inventory to the approved procedure product inventory, and generating a purchase order for the one or more items of the approved procedure product inventory only if the proposed procedure product inventory matches the approved procedure product inventory.

### FIELD

The disclosure relates generally to systems and methods for auditing proposed healthcare purchases. Particular embodiments disclosed herein relate to systems and methods for auditing proposed purchases of regulated medical items, such as medical devices, equipment, and/or other items, prior to issuance of a purchase order.

### BACKGROUND

Hospitals and other healthcare facilities frequently review purchases of healthcare-related items in order to identify waste generated through the purchase of unnecessary goods. Unfortunately, hospitals and healthcare facilities do not have adequate and accurate systems and methods to audit proposed purchases of medical devices, medical equipment, and/or other items prior to the issuance of purchase orders to acquire these items from a manufacturer or distributor. As a result, hospitals and healthcare facilities often purchase unnecessary items that are not used during healthcare procedures.

While purchase review systems and methods may identify this waste, they do not enable its minimization or elimination. As a result, the expenses associated with unnecessary medical items remain in the overall expense of delivering healthcare services.

A need exists, therefore, for improved systems and methods for auditing proposed healthcare purchases.

### BRIEF SUMMARY OF SELECTED EXAMPLES

Various example systems and methods for auditing proposed healthcare purchases are described and illustrated herein.

An example method for auditing proposed healthcare purchases comprises the steps of obtaining from a first source a procedure identifier for a proposed healthcare procedure, obtaining from a second source a proposed procedure product inventory, inputting the procedure identifier into a computer, retrieving from a data store operably connected to the computer an approved procedure product inventory of one or more items for the proposed healthcare procedure represented by the procedure identifier, comparing the proposed procedure product inventory to the approved procedure product inventory, and generating a purchase order for the one or more items of the approved procedure product inventory only if the proposed procedure product inventory matches the approved procedure product inventory.

Another example method for auditing proposed healthcare purchases comprises the steps of compiling on a computer a data store containing one or more approved procedure product inventories of one or more items for one or more healthcare procedures, receiving a procedure identifier, receiving a proposed procedure product inventory, retrieving from the data store an approved procedure product inventory of one or more items for the healthcare procedure represented by the procedure identifier, comparing the proposed procedure product inventory to the approved procedure product inventory, and generating a purchase order for the one or more items of the approved procedure product inventory only if the proposed procedure product inventory matches the approved procedure product inventory.

An example system for auditing proposed healthcare purchases comprises a data store configured to store one or more approved procedure product inventories of one or more items for one or more healthcare procedures, and a computer having a central processing unit and random access memory, the computer operably connected to the data store, the computer configured to receive a first input, receive a second input, retrieve from the data store an approved procedure product inventory of one or more items for the healthcare procedure represented by the first input, compare the second input to the approved procedure product inventory, and generate a purchase order for the one or more items of the approved procedure product inventory only if the second input matches the approved procedure product inventory.

Additional understanding of the systems and methods for auditing proposed healthcare purchases can be obtained by reviewing the detailed description of selected examples, below, and the appended drawings.

### DESCRIPTION OF FIGURES

FIG. 1 illustrates an example system for auditing proposed healthcare purchases.

FIG. 2 schematically shows another example system for auditing proposed healthcare purchases.

FIG. 3 is a flowchart representation of an example method for auditing proposed healthcare purchases.

FIG. 4 is a flowchart representation of another example method for auditing proposed healthcare purchases.

FIG. 5 is a flowchart representation of another example method for auditing proposed healthcare purchases.

FIG. 6 is a flowchart representation of another example method for auditing proposed healthcare purchases.

FIG. 7 is a flowchart representation of another example method for auditing proposed healthcare purchases.

FIG. 8 is a flowchart representation of another example method for auditing proposed healthcare purchases.

FIG. 9 is a flowchart representation of another example method for auditing proposed healthcare purchases.

### DETAILED DESCRIPTION OF SELECTED EXAMPLES

The following detailed description and the appended drawings describe and illustrate various example embodiments. The description and illustration of these selected examples are provided to enable one skilled in the art to make and use the inventive systems and methods. They are not intended to limit the scope of the claims in any manner.

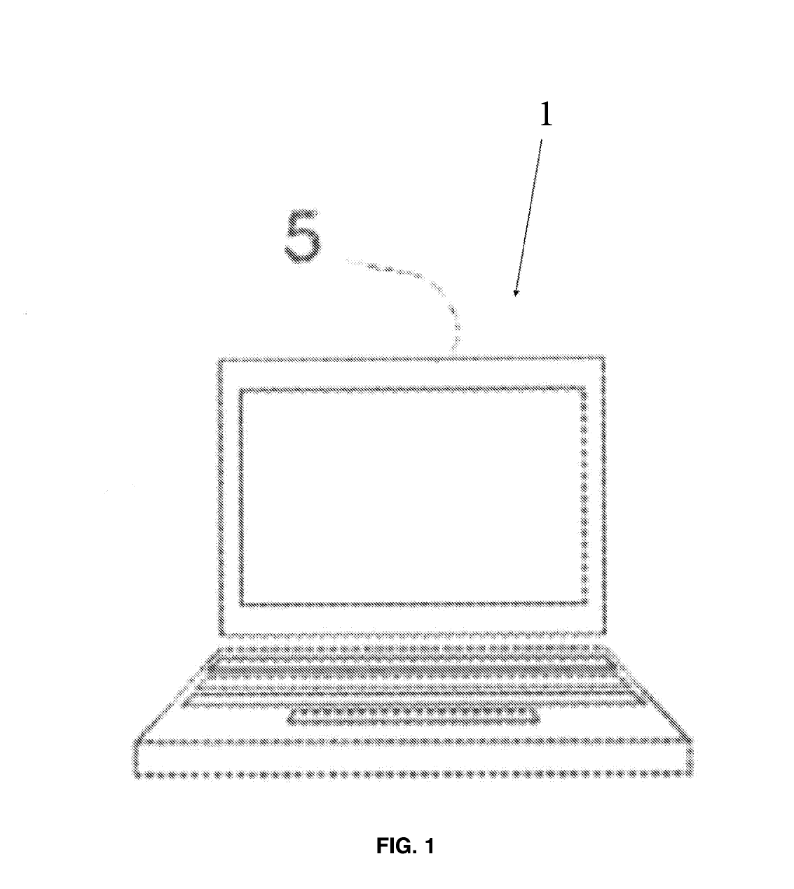

FIG. 1 illustrates an example system for auditing proposed healthcare purchases. The system 1 comprises a computer 5.

The computer 5 includes a central processing unit (“CPU”), random access memory (“RAM”), input and output circuitry for connecting peripheral devices to the computer 5, a display adapter for connecting the computer to a display device, a user interface adapter for connecting user input devices such as a keyboard, a mouse, a microphone, and speakers to the computer 5, and a communication adapter for connecting the computer 5 to a network, if desired. The computer 5, however, may include additional components. A skilled artisan will be able to select suitable components in a particular example based on various considerations, including the programs that the computer will utilize and whether the computer is configured to access a network. In one embodiment, the communication adapter is configured to connect to an external network. In another embodiment, the computer is configured to connect to the Internet via wires and wirelessly.

The CPU of the computer 5 is preferably one or more general-purpose microprocessors or CPUs and has a set of control algorithms, comprising resident program instructions and calibrations stored in the RAM and executed to provide the desired functions, including parallel processing functions. The CPU may have any number of processing cores or electronic architecture configured to execute programs in parallel. The description of the CPU is meant to be illustrative and not restrictive to the disclosure. The disclosure may be implemented on platforms and operating systems other than those mentioned. For example, the CPU may be housed on a desktop computer, a laptop, a tablet, and a mobile device, in various embodiments.

The computer 5 is operably connected to a data store (not illustrated in the Figures). The data store is configured to store medical device and equipment-related data. The computer 5 can comprise any suitable computer adapted to retrieve information from the data store. The computer 5 can include the data store or can be operably connected to the data store, either directly or via a network, such as the Internet. For example, a single computer can include the data store as a local database and can operate a web server for presenting electronic versions of one or both of procedure identifiers and their corresponding approved procedure product inventories to a user. Alternatively, a series of computers may be used. For example, one computer can accept a procedure identifier from the user and prepare and submit a request to another computer that controls the data store. The data store computer can return information to the first computer for presenting electronic versions of one or both of the procedure identifier and its associated approved procedure product inventory or can send the information to another connected computer for presenting electronic versions of one or both of the procedure identifier and/or approved procedure product inventory to the user. Alternatively, or additionally, one or more of the electronic versions of procedure identifiers and/or approved procedure product inventories can be “pre-made” and stored on the computer 5 or on a computer operably connected to the computer. In another alternative, one or more procedure identifiers may be stored as text files on a computer structure. The name or names of the text files may comprise the procedure identifiers or any other number, numbers, letter, letters, symbol, symbols, character, characters, or combination thereof. These text files will include one or more approved procedure product inventory. A skilled artisan will be able to select how to configure the data store according to a particular example based on various considerations, including the number of procedure identifiers and approved procedure product inventories and what other forms of data a particular data store user would like the data store to store. In other embodiments, the data store may also include, for example, additional audio data, video data, and graphical data. In different embodiments, the data store may include patient identification information such as a patient's age, date of birth, social security number, address, and other identifying information. In additional embodiments, the data store may store a history of recent or all procedure identifier selections.

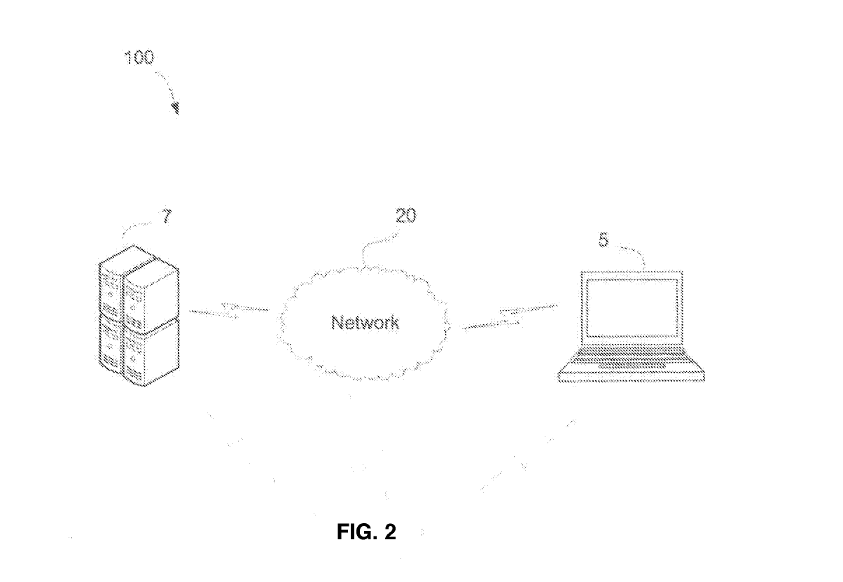

FIG. 2 illustrates another example a system for auditing proposed healthcare purchases 100. The system 100 includes a computer 5, a network 20, and a server system 7.

The computer of the system comprises computer 5, as is generally described above. In other embodiments, though, any computer may be used. A skilled artisan will be able to select a suitable computer according to a particular example based on various considerations, including the desired programs that the computer will utilize and the preferences of the computer's users. In a different embodiment, the computer may comprise a mobile device, such as a mobile phone. In other embodiments, the computer may comprise a laptop, a desktop computer, and a tablet.

The server system 7 may be one or more of various embodiments of a computer, including high-speed microcomputers, minicomputers, mainframes, and data storage devices. The server system 7 executes data store functions, including storing and maintaining a data store (not illustrated in the Figures). This data store is similar to the data store described above and is configured to store procedure identifiers and their corresponding approved procedure product inventories. The server system 7 processes query from the computer 5 and allows the computer 5 to extract data from the data store that corresponds to a particular procedure identifier, which is described in greater detail below.

The network 20 may be any suitable series of points or nodes interconnected by communication paths. The network 20 may be interconnected with other networks and contain sub-networks such as, for example, a publicly accessible distributed network like the Internet or other telecommunications networks (e.g., intranets, virtual nets, overlay networks, and other networks). The network 20 facilitates the exchange of data between and between the computer 5 and the server system 7.

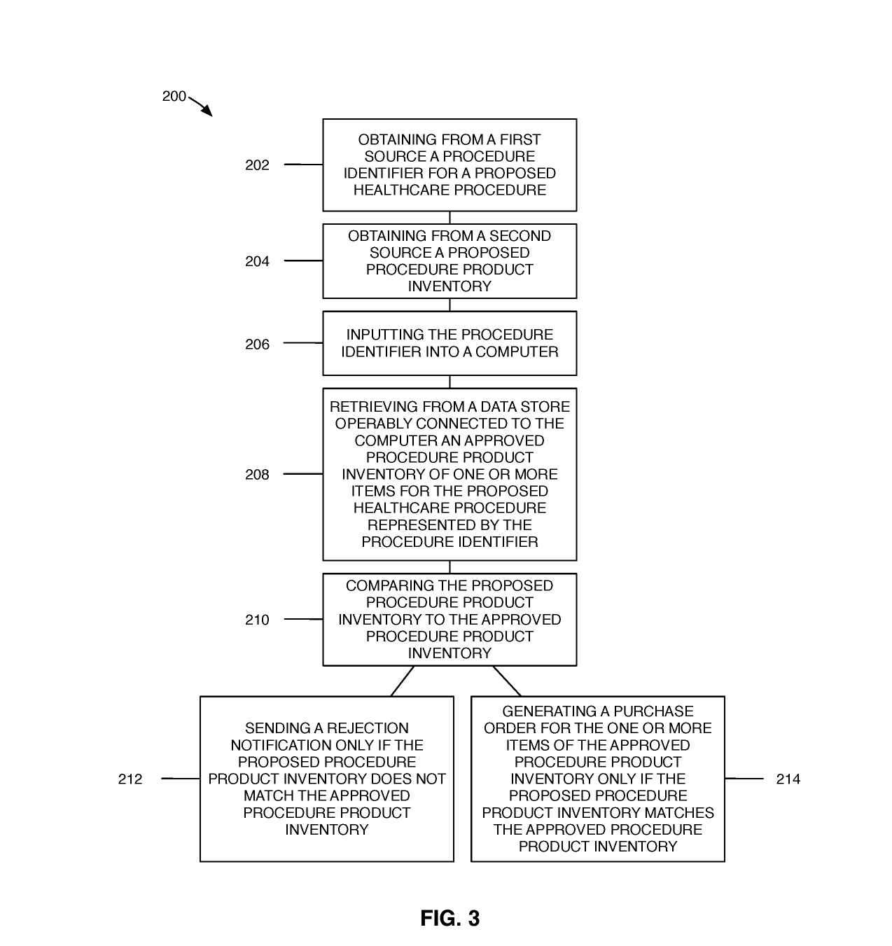

FIG. 3 is a flowchart representation of an example method 200 for auditing proposed healthcare purchases. This method 200 can be used for auditing proposed healthcare purchases. It can also be used for auditing proposed non-healthcare purchases. This method 200 may be performed at any healthcare facility, including a hospital, a nursing home, an outpatient facility, a group purchasing organization (“GPO”) and a healthcare clinic. Various functions of the method 200 may be executed on a computer, such as computer 5 described above, in one embodiment. In another embodiment, the method 200 may be executed on a system for auditing proposed healthcare purchases, such as system 100. In other embodiments, the method 200 may be performed on any computer and on any system.

An initial step 202 comprises obtaining from a first source a procedure identifier for a proposed healthcare procedure. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

In this embodiment, the first source comprises a physician or another healthcare service provider. However, the first source may comprise any individual employed by, contracted to work for, or acting as a volunteer for a healthcare facility. A skilled artisan will be able to determine a suitable first source according to a particular example based on various considerations, including the organizational structure of the healthcare facility. In another embodiment, the first source may comprise a healthcare administrator. In a different embodiment, the first source may comprise a nurse. In an alternative embodiment, the first source may be one or more of a physician or another healthcare service provider and a healthcare administrator, and the person obtaining the procedure identifier may be required to cross-reference the information obtained from one of these individuals with another previously-listed first source. For example, the person obtaining the procedure identifier from a healthcare service provider may need to acquire verification from a healthcare administrator that the correct procedure identifier was obtained, in such an embodiment.

Another step 204 comprises obtaining from a second source a proposed procedure product inventory. A proposed procedure product inventory is an inventory containing the proposed devices, equipment, and/or items to be used in a particular surgery or healthcare procedure. The proposed procedure product inventory may be generated based on the procedure identifier described above.

The second source can be a person or a resource. For example, in this embodiment the second source comprises a healthcare service provider. However, the second source may comprise any individual employed by, contracted to work for, or acting as a volunteer for a healthcare facility in other embodiments. A skilled artisan will be able to determine a suitable second source according to a particular example based on various considerations, including the organizational structure of the healthcare facility. In another embodiment, the second source may comprise a physician or another healthcare service provider. In a different embodiment, the second source may comprise a nurse. In other embodiments, the second source may comprise one or more of a book, booklet, logbook, physical or electronic data store, software program, instructions for use document, and a listing of medical devices, equipment, and/or items used in previous procedures having the same procedure identifier. Additionally, in an alternative embodiment, the second source may be one or more of a physician or another healthcare service provider and a healthcare administrator, and the person obtaining the proposed procedure product inventory may be required to cross-reference the information obtained from one of these individuals with another previously-listed second source. For example, the person obtaining the proposed procedure product inventory from a healthcare administrator may need to acquire verification from a booklet or instructions for use document that the correct proposed procedure product information was obtained. Alternatively, the first source and the second source may comprise the same source.

Another step 206 comprises inputting the procedure identifier into a computer. The computer may comprise computer 5, as described above, in this embodiment. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device.

Another step 208 comprises retrieving an approved procedure product inventory comprising one or more items from a data store operably connected to the computer. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is input in step 206, into an appropriate query.

The approved procedure product inventory contains an official list of approved medical devices, equipment, and/or items that are used in a particular surgery or healthcare procedure. It is associated with the procedure identifier that is input in step 206. The approved procedure product inventory may comprise any list of items, including one or more of medical devices, equipment, and/or other items. A skilled artisan will be able to suitably configure the retrieving step according to a particular example based on various considerations, including the configuration of the healthcare facility's computer network. In one embodiment, the data store may be stored on the computer itself. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

The approved procedure product inventory is contained on the data store, described above. The data store contains instructions for use provided by a manufacturer that corresponds to the procedure identifier. The data store is stored on a server and the computer accesses the server via a network to retrieve the approved procedure product inventory from the data store. A skilled artisan will be able to determine how to suitably retrieve the approved procedure product inventory from the data store according to a particular example based on various considerations, including the size of the data store and the configuration of the healthcare facility's computing system. In one embodiment, the data store may be stored on the computer. In a different embodiment, the data store may be stored on a server and the computer may directly access the data store, without the use of a network, to retrieve the approved procedure product inventory from the data store. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians or another healthcare service providers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 210 comprises comparing the proposed procedure product inventory to the approved procedure product inventory. The computer performs this step. This comparison ensures that the proposed procedure product inventory contains the same devices, equipment, and/or items that are contained in the approved procedure product inventory. However, this step may only be partially performed by the computer. In another embodiment, the server may perform this step after receiving a proposed procedure product inventory from the computer, such as computer 5, and transmit the results of the comparison to the computer.

Another step 212 comprises sending a rejection notification if the proposed procedure product inventory does not match the approved procedure product inventory. The rejection notification is generated by the computer and is displayed to inform the user that the proposed procedure product inventory includes different data than that required by the approved procedure product inventory. The rejection notification will appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears on the computer. Such another rejection notification may be sent electronically, via the network. It may also be physically printed via a printer that forms a connection with the computer. In another embodiment, the computer may allow for its user to re-input the proposed procedure product inventory and subsequently perform another comparison of the proposed procedure product inventory and approved procedure product inventory.

Another step 214 comprises generating a purchase order for the one or more items of the approved procedure product inventory only if the items of the proposed procedure product inventory match the items of the approved procedure product inventory. In such an instance, the computer will automatically generate a purchase order that includes all medical devices and equipment of the proposed and approved procedure product inventories. In other embodiments, a computer can inform a server that the proposed and approved procedure product inventories match, the server can send this information to a second computer, and the second computer can generate the purchase order.

In a different embodiment, the purchase order may still be generated if a certain threshold for items of the approved procedure purchase inventory is met. More specifically, if a certain percentage of the proposed procedure product inventory and approved procedure product inventory match (and that percentage is less than one-hundred percent), a purchase order may still be generated. A skilled artisan will be able to determine such a suitable threshold according to a particular example based on various considerations, including the individual procedure and the particular items of the approved procedure product inventory. In various examples, any match percentage between the proposed procedure product inventory and approved procedure product inventory may result in the generation of a purchase order, including between about 50% and about 99%, between about 60% and about 90%, and between about 70% and about 80%.

It is noted that the method 200 may be completed in the order illustrated and described. However, the steps may also be completed in any order.

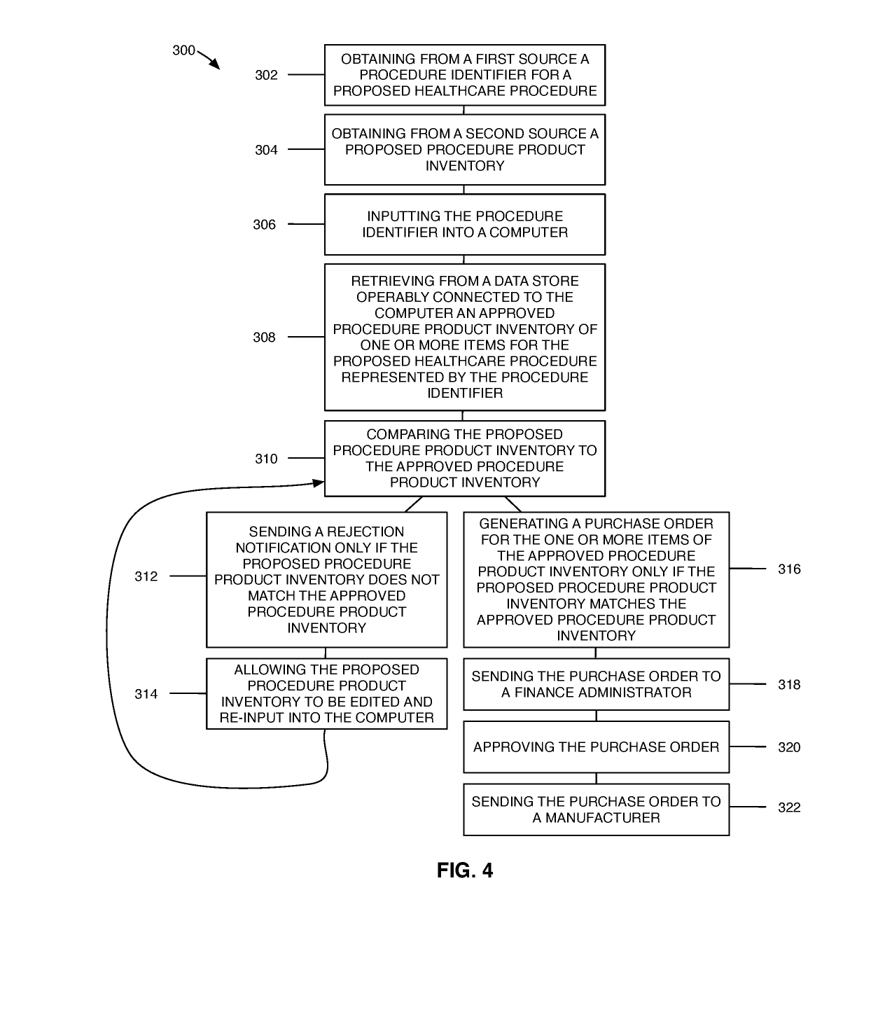

FIG. 4 is a flowchart representation of an example method 300 for auditing proposed healthcare purchases. This method 300 can be used for auditing proposed healthcare purchases. It can also be used for auditing proposed non-healthcare purchases. This method 300 may be performed at any healthcare facility, including a hospital, a nursing home, an outpatient facility, a GPO, and a healthcare clinic. Various functions of the method 300 may be executed on a computer, such as computer 5 described above, in one embodiment. In another embodiment, the method 300 may be executed on a system for auditing proposed healthcare purchases, such as system 100. In other embodiments, the method 300 may be performed on any computer and on any system.

An initial step 302 comprises obtaining from a first source a procedure identifier for a proposed healthcare procedure. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

In this embodiment, the first source comprises a physician or another healthcare service provider. However, the first source may comprise any individual employed by, contracted to work for, or acting as a volunteer for a healthcare facility. A skilled artisan will be able to determine a suitable first source according to a particular example based on various considerations, including the organizational structure of the healthcare facility. In another embodiment, the first source may comprise a healthcare administrator. In a different embodiment, the first source may comprise a nurse. In an alternative embodiment, the first source may be one or more of a physician or another healthcare service provider and a healthcare administrator, and the person obtaining the procedure identifier may be required to cross-reference the information obtained from one of these individuals with another previously-listed first source. For example, the person obtaining the procedure identifier from a healthcare service provider may need to acquire verification from a healthcare administrator that the correct procedure identifier was obtained, in such an embodiment.

Another step 304 comprises obtaining from a second source a proposed procedure product inventory. A proposed procedure product inventory is an inventory containing the proposed devices, equipment, and/or items to be used in a particular surgery or healthcare procedure. The proposed procedure product inventory may be generated based on the procedure identifier described above.

The second source can be a person or a resource. For example, in this embodiment the second source comprises a healthcare service provider. However, the second source may comprise any individual employed by, contracted to work for, or acting as a volunteer for a healthcare facility in other embodiments. A skilled artisan will be able to determine a suitable second source according to a particular example based on various considerations, including the organizational structure of the healthcare facility. In another embodiment, the second source may comprise a physician, a materials management person, or another healthcare service provider. In a different embodiment, the second source may comprise a nurse. In other embodiments, the second source may comprise one or more of a book, booklet, logbook, physical or electronic data store, software program, instructions for use document, and a listing of medical devices, equipment, and/or items used in previous procedures having the same procedure identifier. Additionally, in an alternative embodiment, the second source may be one or more of a physician, a materials management person, or another healthcare service provider and a healthcare administrator, and the person obtaining the proposed procedure product inventory may be required to cross-reference the information obtained from one of these individuals with another previously-listed second source. For example, the person obtaining the proposed procedure product inventory from a healthcare administrator may need to acquire verification from a booklet or instructions for use document that the correct proposed procedure product information was obtained. Alternatively, the first source and the second source may comprise the same source.

Another step 306 comprises inputting the procedure identifier into a computer. The computer may comprise computer 5, as described above, in this embodiment. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device.

Another step 308 comprises retrieving an approved procedure product inventory comprising one or more items from a data store operably connected to the computer. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is input in step 206, into an appropriate query.

The approved procedure product inventory contains an official list of approved medical devices, equipment, and/or items that are used in a particular surgery or healthcare procedure. It is associated with the procedure identifier that is input in step 306. The approved procedure product inventory may comprise any list of items, including one or more of medical devices, equipment, and/or other items. A skilled artisan will be able to suitably configure the retrieving step according to a particular example based on various considerations, including the configuration of the healthcare facility's computer network. In one embodiment, the data store may be stored on the computer itself. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

The approved procedure product inventory is contained on the data store, described above. The data store contains instructions for use provided by a manufacturer that corresponds to the procedure identifier. The data store is stored on a server and the computer accesses the server via a network to retrieve the approved procedure product inventory from the data store. A skilled artisan will be able to determine how to suitably retrieve the approved procedure product inventory from the data store according to a particular example based on various considerations, including the size of the data store and the configuration of the healthcare facility's computing system. In one embodiment, the data store may be stored on the computer. In a different embodiment, the data store may be stored on a server and the computer may directly access the data store, without the use of a network, to retrieve the approved procedure product inventory from the data store. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 310 comprises comparing the proposed procedure product inventory to the approved procedure product inventory. The computer performs this step. This comparison ensures that the proposed procedure product inventory contains the same devices, equipment, and/or items that are contained in the approved procedure product inventory. However, this step may only be partially performed by the computer. In another embodiment, the server may perform this step after receiving a proposed procedure product inventory from the computer, such as computer 5, and transmit the results of the comparison to the computer.

Another step 312 comprises sending a rejection notification if the proposed procedure product inventory does not match the approved procedure product inventory. The rejection notification is generated by the computer and is displayed to inform the user that the proposed procedure product inventory includes different data than that required by the approved procedure product inventory. The rejection notification will appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears on the computer. Such another rejection notification may be sent electronically, via the network. It may also be physically printed via a printer that forms a connection with the computer. In another embodiment, the computer may allow for its user to re-input the proposed procedure product inventory and subsequently perform another comparison of the proposed procedure product inventory and approved procedure product inventory.

Another step 314 comprises allowing the proposed procedure product inventory to be edited and re-input into the computer. If the user of the computer has incorrectly input one or more medical devices, equipment, and/or items into the computer, the user will be able to input the proposed procedure product inventory into the computer again. After the proposed procedure product inventory has been resubmitted, the computer will then compare the re-submitted devices, equipment, and/or items to items of the approved procedure product inventory. This comparison is described in step 310. The step of editing and re-inputting the proposed procedure product inventory may occur zero, one, two, three, four, or more than four times.

Another step 316 comprises generating a purchase order for the one or more items of the approved procedure product inventory only if the items of the proposed procedure product inventory match the items of the approved procedure product inventory. In such an instance, the computer will automatically generate a purchase order that includes all medical devices and equipment of the proposed and approved procedure product inventories. In other embodiments, a computer can inform a server that the proposed and approved procedure product inventories match, the server can send this information to a second computer, and the second computer can generate the purchase order.

In a different embodiment, the purchase order may still be generated if a certain threshold for items of the approved procedure purchase inventory is met. More specifically, if a certain percentage of the proposed procedure product inventory and approved procedure product inventory match (and that percentage is less than one-hundred percent), a purchase order may still be generated. A skilled artisan will be able to determine such a suitable threshold according to a particular example based on various considerations, including the individual procedure and the particular items of the approved procedure product inventory. In various examples, any match percentage between the proposed procedure product inventory and approved procedure product inventory may result in the generation of a purchase order, including between about 50% and about 99%, between about 60% and about 90%, and between about 70% and about 80%.

Another step 318 comprises sending the purchase order generated in step 316 to a finance administrator employed by, contracted to work for, or acting as a volunteer for the healthcare facility. The purchase order will be electronically sent to the finance administrator via the Internet, such as through email, through the computer in this embodiment. However, the purchase order may be sent to any person and may be sent by any means. A skilled artisan will be able to suitably determine the person that will receive the purchase order and the means by which it will be sent according to a particular example based on various considerations, including the corporate structure of the healthcare facility and its communication procedures. In different embodiments, any healthcare facility employee may be sent the purchase order, including a device purchaser, materials management person, executive, accountant, attorney, physician or another healthcare service provider, and device salesperson liaison. In other embodiments, the purchase order may be sent to a healthcare facility employee via a fax, an intranet, an internal messaging system, a text message, an alert on his or her respective computer, and by physically printing a copy of the purchase order on the employee's printer. Additionally, these purchase orders may be communicated from the computer referenced above to another computer in any manner, including via a network, through a server, and directly from computer to computer in alternate embodiments. Alternatively, an invoice may be generated, rather than a purchase order.

Another step 320 comprises approving the purchase order. The finance administrator approves the purchase order via his or her computer. However, any employee, contractor, or volunteer of the healthcare facility may approve the purchase order. A skilled artisan will be able to determine a suitable individual to approve the purchase order based on various considerations, including the corporate structure of the healthcare facility. In other embodiments, any healthcare facility employee may approve the purchase order, including a device purchaser, executive, accountant, attorney, physician, materials management person, or another healthcare service provider, and device salesperson liaison. In different embodiments, the purchase order may be approved in any manner, including via a computer connected to a network that is connected to a server, over an intranet, over the Internet, via email, via fax, and manually by a healthcare facility employee.

Another step 322 comprises sending the purchase order to a manufacturer of the medical devices, equipment, and/or items. The purchase order is sent via email over the Internet in this step. The purchase order is sent by a computer. The purchase order is sent by the finance administrator in this embodiment. A skilled artisan will be able to determine how best to send the purchase order to a manufacturer or other entity according to a particular example based on various considerations, including the employee, contractor, and volunteer structure of the healthcare facility and the preferences of the manufacturer or other entity. In other embodiments, any healthcare facility employee, including a device purchaser, executive, accountant, attorney, physician, materials management person, or another healthcare service provider, and device salesperson liaison, may send the purchase order. Additionally, the purchase order may be sent in any manner, including via a computer connected to a network that is connected to a server, over an intranet, over the Internet, via email, via fax, and manually by a healthcare facility employee in various embodiments. In different embodiments, the purchase order may be sent to any entity, including a vendor, salesperson, distributor, purchaser, and seller.

It is noted that the method 300 may be completed in the order illustrated and described. However, the steps may also be completed in any order.

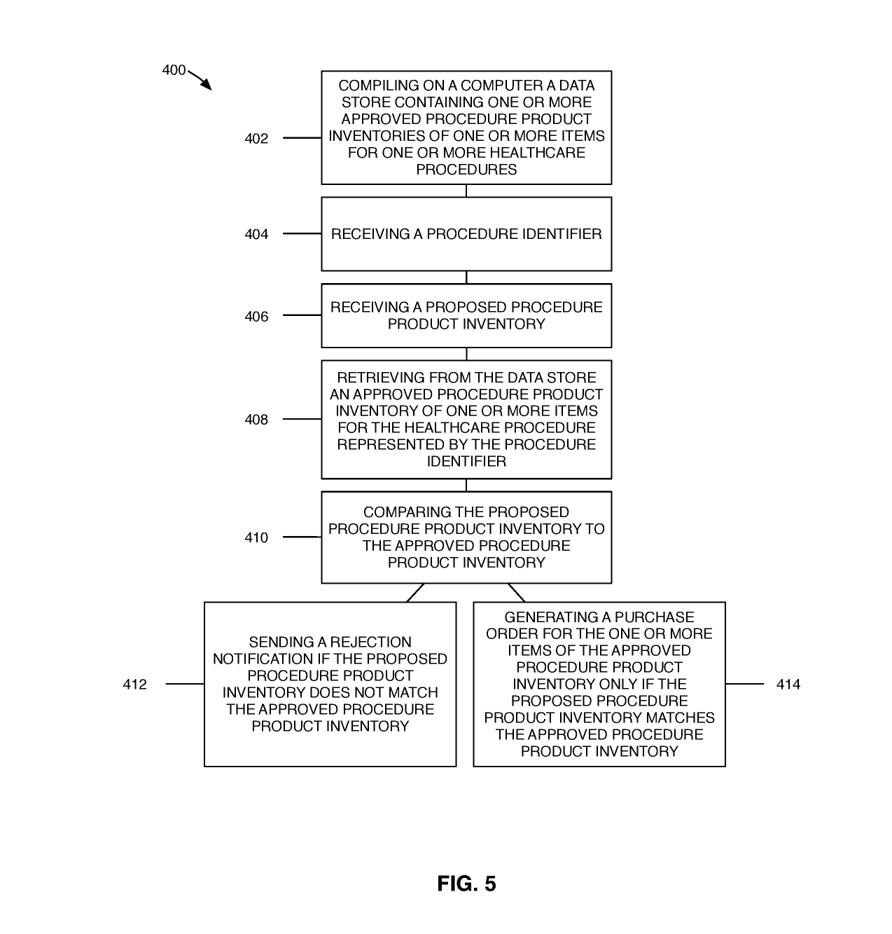

FIG. 5 is a flowchart representation of an example method 400 for auditing proposed healthcare purchases. This method 400 can be used for auditing any proposed healthcare purchases. It can also be used to audit proposed non-healthcare purchases. This method 400 may be performed at any healthcare facility, including a hospital, a nursing home, an outpatient facility, a GPO, and a healthcare clinic. Various functions of the method 400 may be executed on a computer, such as computer 5 described above, in one embodiment. In another embodiment, the method 400 may be executed on a system for auditing proposed healthcare purchases, such as system 100. In other embodiments, the method 400 may be performed on any computer and on any system.

An initial step 402 comprises compiling on a computer a data store containing one or more approved procedure product inventories of one or more items for one or more healthcare procedures. Computer 5 may comprise the computer. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device. In a different embodiment, the data store may be stored on a medium that is not the computer.

The computer is operably connected to a data store (not illustrated in the Figures). The data store is configured to store medical device and equipment-related data. The computer can comprise any suitable computer adapted to retrieve information from the data store. The computer can include the data store or can be operably connected to the data store, either directly or via a network, such as the Internet. For example, a single computer can include the data store as a local database and can operate a web server for presenting electronic versions of one or both of procedure identifiers and their corresponding approved procedure product inventories to a user. Alternatively, a series of computers may be used. For example, one computer can accept a procedure identifier from the user and prepare and submit a request to another computer that controls the data store. The data store computer can return information to the first computer for presenting electronic versions of one or both of the procedure identifier and its associated approved procedure product inventory or can send the information to another connected computer for presenting electronic versions of one or both of the procedure identifier and/or approved procedure product inventory to the user. Alternatively, or additionally, one or more of the electronic versions of procedure identifiers and/or approved procedure product inventories can be “pre-made” and stored on the computer or on a computer operably connected to the computer. In another alternative, one or more procedure identifiers may be stored as text files on a computer structure. The name or names of the text files may comprise the procedure identifiers or any other number, numbers, letter, letters, symbol, symbols, character, characters, or combination thereof. These text files will include one or more approved procedure product inventory. A skilled artisan will be able to select how to configure the data store according to a particular example based on various considerations, including the number of procedure identifiers and approved procedure product inventories and what other forms of data a particular data store user would like the data store to store. In other embodiments, the data store may also include, for example, additional audio data, video data, and graphical data. In different embodiments, the data store may include patient identification information such as a patient's age, date of birth, social security number, address, and other identifying information. In additional embodiments, the data store may store a history of recent or all procedure identifier selections.

Approved procedure product inventories contain official lists of approved medical devices, equipment, and/or items that are used in particular surgeries or healthcare procedures and are associated with specific procedure identifiers in this embodiment. They are contained on the data store that is operably connected to the computer. The data store contains instructions for use provided by manufacturers that correspond to procedure identifiers, described below. A skilled artisan will be able to determine how to suitably compile the approved procedure product inventories on the data store according to a particular example based on various considerations, including the size of the data store and the configuration of the healthcare facility's computing system. In another embodiment, the data store may be stored on a server. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, other healthcare workers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 404 comprises receiving a procedure identifier. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

Another step 406 comprises receiving a proposed procedure product inventory. A proposed procedure product inventory is an inventory containing the proposed devices, equipment, and/or items to be used in a particular surgery or healthcare procedure. The proposed procedure product inventory may be generated based on the procedure identifier described above.

In this embodiment, the particular individual entering the procedure identifier of step 404 and proposed procedure product inventory of step 406 comprises a healthcare administrator. However, the user may comprise any person employed by, contracted to work for, or acting as a volunteer for the healthcare facility in other embodiments. A skilled artisan will be able to determine a suitable configuration based upon a particular user according to a particular example based on various considerations, including the organizational structure of the healthcare facility. In other embodiment, the user may comprise any of a physician or another healthcare service provider, an administrator of any type, an accountant, and an attorney.

Another step 408 comprises retrieving from the data store an approved procedure product inventory of one or more items for the healthcare procedure represented by the procedure identifier. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is received in step 406, into an appropriate query. The approved procedure product inventory may be retrieved from any source, however. A skilled artisan will be able to determine how to suitably retrieve the approved procedure product inventory from the data store according to a particular example based on various considerations, including the size of the data store and the configuration of the healthcare facility's computing system. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

Another step 410 comprises comparing the proposed procedure product inventory to the approved procedure product inventory. The computer performs this step. This comparison ensures that the proposed procedure product inventory contains the same devices, equipment, and/or items contained in the approved procedure product inventory. However, this step may only be partially performed by the computer. In another embodiment, the server may perform this step after receiving a proposed procedure product inventory from the computer, such as computer 5, and transmit the results of the comparison to the computer.

Another step 412 comprises sending a rejection notification if the proposed procedure product inventory does not match the approved procedure product inventory. The rejection notification is generated by the computer and is displayed to inform the user that the proposed procedure product inventory includes different data than that required by the approved procedure product inventory. The rejection notification will appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears is sent to the user. Such another rejection notification may be sent electronically, via the network. It may also be physically printed via a printer that forms a connection with the computer. In another embodiment, the computer may allow for its user to re-input the proposed procedure product inventory and subsequently perform another comparison of the proposed procedure product inventory and approved procedure product inventory.

Another step 414 comprises generating a purchase order for the one or more items of the approved procedure product inventory only if the proposed procedure product inventory matches the approved procedure product inventory. In such an instance, the computer will automatically generate a purchase order that includes all medical devices and equipment of the proposed and approved procedure product inventories. In other embodiments, a computer can inform a server that the proposed and approved procedure product inventories match, the server can send this information to a second computer, and the second computer can generate the purchase order.

In a different embodiment, the purchase order may still be generated if a certain threshold for items of the approved procedure purchase inventory is met. More specifically, if a certain percentage of the proposed procedure product inventory and approved procedure product inventory match (and that percentage is less than one-hundred percent), a purchase order may still be generated. A skilled artisan will be able to determine such a suitable threshold according to a particular example based on various considerations, including the individual procedure and the particular items of the approved procedure product inventory. In various examples, any match percentage between the proposed procedure product inventory and approved procedure product inventory may result in the generation of a purchase order, including between about 50% and about 99%, between about 60% and about 90%, and between about 70% and about 80%.

It is noted that the method 400 may be completed in the order illustrated and described. However, the steps may also be completed in any order.

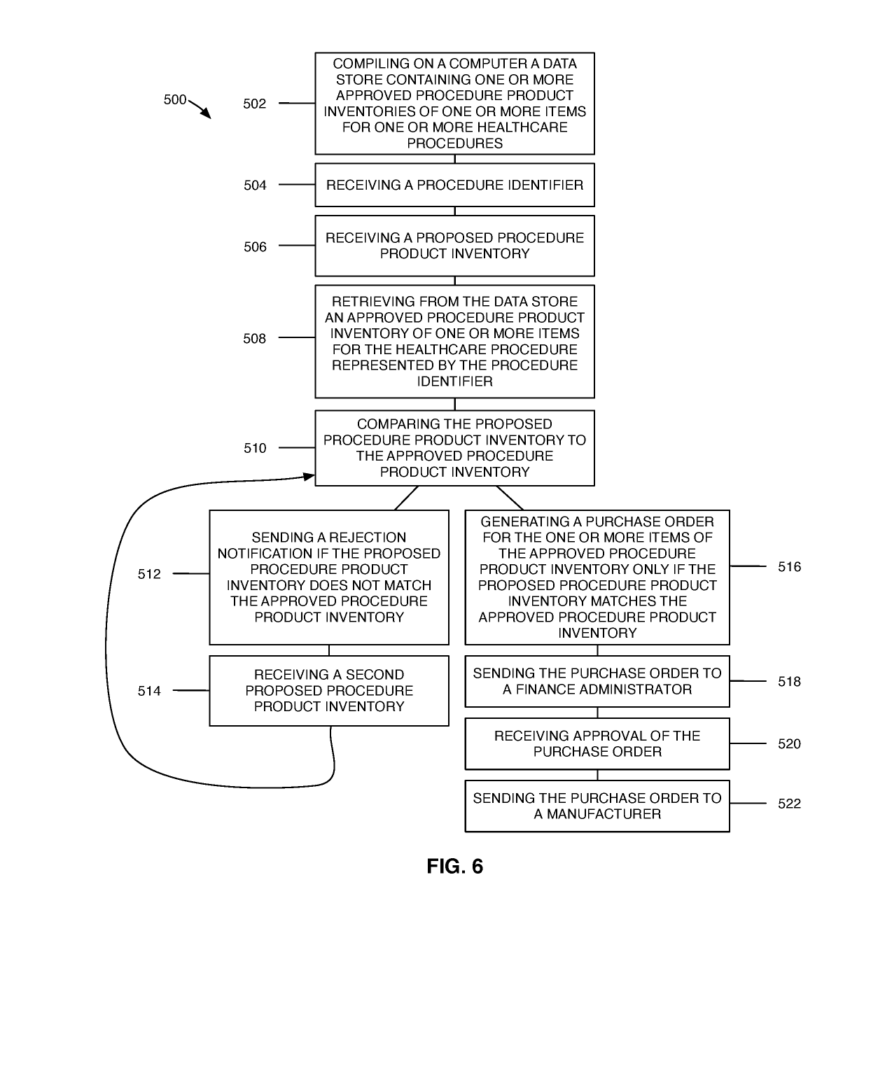

FIG. 6 is a flowchart representation of an example method 500 for auditing proposed healthcare purchases. This method 500 can be used for auditing any proposed healthcare purchases. It can also be used to audit proposed non-healthcare purchases. This method 500 may be performed at any healthcare facility, including a hospital, a nursing home, an outpatient facility, a GPO, and a healthcare clinic. Various functions of the method 500 may be executed on a computer, such as computer 5 described above, in one embodiment. In another embodiment, the method 500 may be executed on a system for auditing proposed healthcare purchases, such as system 100. In other embodiments, the method 500 may be performed on any computer and on any system.

An initial step 502 comprises compiling on a computer a data store containing one or more approved procedure product inventories of one or more items for one or more healthcare procedures. Computer 5 may comprise the computer. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device. In a different embodiment, the data store may be stored on a medium that is not the computer.

The computer is operably connected to a data store (not illustrated in the Figures). The data store is configured to store medical device and equipment-related data. The computer can comprise any suitable computer adapted to retrieve information from the data store. The computer can include the data store or can be operably connected to the data store, either directly or via a network, such as the Internet. For example, a single computer can include the data store as a local database and can operate a web server for presenting electronic versions of one or both of procedure identifiers and their corresponding approved procedure product inventories to a user. Alternatively, a series of computers may be used. For example, one computer can accept a procedure identifier from the user and prepare and submit a request to another computer that controls the data store. The data store computer can return information to the first computer for presenting electronic versions of one or both of the procedure identifier and its associated approved procedure product inventory or can send the information to another connected computer for presenting electronic versions of one or both of the procedure identifier and/or approved procedure product inventory to the user. Alternatively, or additionally, one or more of the electronic versions of procedure identifiers and/or approved procedure product inventories can be “pre-made” and stored on the computer or on a computer operably connected to the computer. In another alternative, one or more procedure identifiers may be stored as text files on a computer structure. The name or names of the text files may comprise the procedure identifiers or any other number, numbers, letter, letters, symbol, symbols, character, characters, or combination thereof. These text files will include one or more approved procedure product inventory. A skilled artisan will be able to select how to configure the data store according to a particular example based on various considerations, including the number of procedure identifiers and approved procedure product inventories and what other forms of data a particular data store user would like the data store to store. In other embodiments, the data store may also include, for example, additional audio data, video data, and graphical data. In different embodiments, the data store may include patient identification information such as a patient's age, date of birth, social security number, address, and other identifying information. In additional embodiments, the data store may store a history of recent or all procedure identifier selections.

Approved procedure product inventories contain official lists of approved medical devices, equipment, and/or items that are used in particular surgeries or healthcare procedures and are associated with specific procedure identifiers in this embodiment. They are contained on the data store that is operably connected to the computer. The data store contains instructions for use provided by manufacturers that correspond to procedure identifiers, described below. A skilled artisan will be able to determine how to suitably compile the approved procedure product inventories on the data store according to a particular example based on various considerations, including the size of the data store and the configuration of the healthcare facility's computing system. In another embodiment, the data store may be stored on a server. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, other healthcare workers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 504 comprises receiving a procedure identifier. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

Another step 506 comprises receiving a proposed procedure product inventory. A proposed procedure product inventory is an inventory containing the proposed devices, equipment, and/or items to be used in a particular surgery or healthcare procedure. The proposed procedure product inventory may be generated based on the procedure identifier described above.

In this embodiment, the particular individual entering the procedure identifier of step 504 and proposed procedure product inventory of step 506 comprises a healthcare administrator. However, the user may comprise any person employed by, contracted to work for, or acting as a volunteer for the healthcare facility in other embodiments. A skilled artisan will be able to determine a suitable configuration based upon a particular user according to a particular example based on various considerations, including the organizational structure of the healthcare facility. In other embodiment, the user may comprise any of a physician or another healthcare service provider, an administrator of any type, an accountant, and an attorney.

Another step 508 comprises retrieving from the data store an approved procedure product inventory of one or more items for the healthcare procedure represented by the procedure identifier. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is received in step 406, into an appropriate query. The approved procedure product inventory may be retrieved from any source, however. A skilled artisan will be able to determine how to suitably retrieve the approved procedure product inventory from the data store according to a particular example based on various considerations, including the size of the data store and the configuration of the healthcare facility's computing system. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

Another step 510 comprises comparing the proposed procedure product inventory to the approved procedure product inventory. The computer performs this step. This comparison ensures that the proposed procedure product inventory contains the same devices, equipment, and/or items contained in the approved procedure product inventory. However, this step may only be partially performed by the computer. In another embodiment, the server may perform this step after receiving a proposed procedure product inventory from the computer, such as computer 5, and transmit the results of the comparison to the computer.

Another step 512 comprises sending a rejection notification if the proposed procedure product inventory does not match the approved procedure product inventory. The rejection notification is generated by the computer and is displayed to inform the user that the proposed procedure product inventory includes different data than that required by the approved procedure product inventory. The rejection notification will appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears is sent to the user. Such another rejection notification may be sent electronically, via the network. It may also be physically printed via a printer that forms a connection with the computer. In another embodiment, the computer may allow for its user to re-input the proposed procedure product inventory and subsequently perform another comparison of the proposed procedure product inventory and approved procedure product inventory.

Another step 514 comprises receiving a second proposed procedure product inventory. The second proposed procedure product inventory will comprise a proposed procedure product inventory that has been edited and revised by a user in order to match the approved procedure product inventory. The second procedure product inventory is input into the computer. After the second proposed procedure product inventory has been received, the computer will then compare the medical devices, equipment, and/or items of the second proposed procedure product inventory to the approved procedure product inventory in a manner similar to that described in step 510. The step of receiving a second proposed procedure product inventory may occur zero, one, two, three, four, or more than four times.

Another step 516 comprises generating a purchase order for the one or more items of the approved procedure product inventory only if the proposed procedure product inventory matches the approved procedure product inventory. In such an instance, the computer will automatically generate a purchase order that includes all medical devices and equipment of the approved procedure product inventory. In other embodiments, a computer can inform a server that the proposed and approved procedure product inventories match, the server can send this information to a second computer, and the second computer can generate the purchase order including the one or more items of the approved procedure product inventory.

In a different embodiment, the purchase order may still be generated if a certain threshold for items of the approved procedure purchase inventory is met. More specifically, if a certain percentage of the proposed procedure product inventory and approved procedure product inventory match (and that percentage is less than one-hundred percent), a purchase order may still be generated. A skilled artisan will be able to determine such a suitable threshold according to a particular example based on various considerations, including the individual procedure and the particular items of the approved procedure product inventory. In various examples, any match percentage between the proposed procedure product inventory and approved procedure product inventory may result in the generation of a purchase order, including between about 50% and about 99%, between about 60% and about 90%, and between about 70% and about 80%.

Another step 518 comprises sending the purchase order generated in step 516 to a finance administrator employed by, contracted to work for, or acting as a volunteer for the healthcare facility. The purchase order will be electronically sent to the finance administrator via the Internet, such as through email, through the computer in this embodiment. However, the purchase order may be sent to any person and may be sent by any means. A skilled artisan will be able to suitably determine the person that will receive the purchase order and the means by which it will be sent according to a particular example based on various considerations, including the corporate structure of the healthcare facility and its communication procedures. In different embodiments, any healthcare facility employee may receive the purchase order, including a device purchaser, executive, accountant, attorney, physician, materials management person, or another healthcare service provider, and device salesperson liaison. In other embodiments, the purchase order may be sent to a healthcare facility employee via a fax, an intranet, an internal messaging system, a text message, an alert on his or her respective computer, and by physically printing a copy of the purchase order on the employee's printer. Additionally, these purchase orders may be communicated from the computer referenced above to another computer in any manner, including via a network, through a server, and directly from computer to computer in alternate embodiments. Alternatively, an invoice may be generated, rather than a purchase order.

Another step 520 comprises receiving approval of the purchase order. The purchase order is approved by the finance administrator in this embodiment. The purchase order is approved by the finance administrator via his or her computer, which is then communicated to the computer. The computer accepts this approval upon receipt. However, any employee or contractor or volunteer working for the healthcare facility may approve the purchase order. A skilled artisan will be able to determine a suitable individual to approve the purchase order based on various considerations, including the corporate structure of the healthcare facility. In other embodiments, any healthcare facility employee may approve the purchase order, including a device purchaser, materials management person, executive, accountant, attorney, physician or another healthcare service provider, and device salesperson liaison. In different embodiments, the purchase order may be approved in any manner, including via a computer connected to a network that is connected to a server, over an intranet, over the Internet, via email, via fax, and manually approved by a healthcare facility employee. Additionally, in another embodiment, the user of the computer may approve the purchase order without sending it to another computer.

Another step 522 comprises sending the purchase order to a manufacturer of the medical devices, equipment, and/or items. The purchase order is sent via email over the Internet in this step by the computer. A skilled artisan will be able to determine how best to send the purchase order to a manufacturer or other entity according to a particular example based on various considerations, including the employee structure of the healthcare facility and the preferences of the manufacturer or other entity. In other embodiments, any healthcare facility employee, including a device purchaser, executive, accountant, attorney, physician, materials management person, or another healthcare service provider, and device salesperson liaison via other computers, may send the purchase order. Additionally, the purchase order may be sent in any manner, including via a computer connected to a network that is connected to a server, over an intranet, over the Internet, via email, via fax, and manually by a healthcare facility employee in various embodiments. In different embodiments, the purchase order may be sent to any entity, including a vendor, salesperson, distributor, purchaser, and seller.

It is noted that the method 500 may be completed in the order illustrated and described. However, the steps may also be completed in any order.

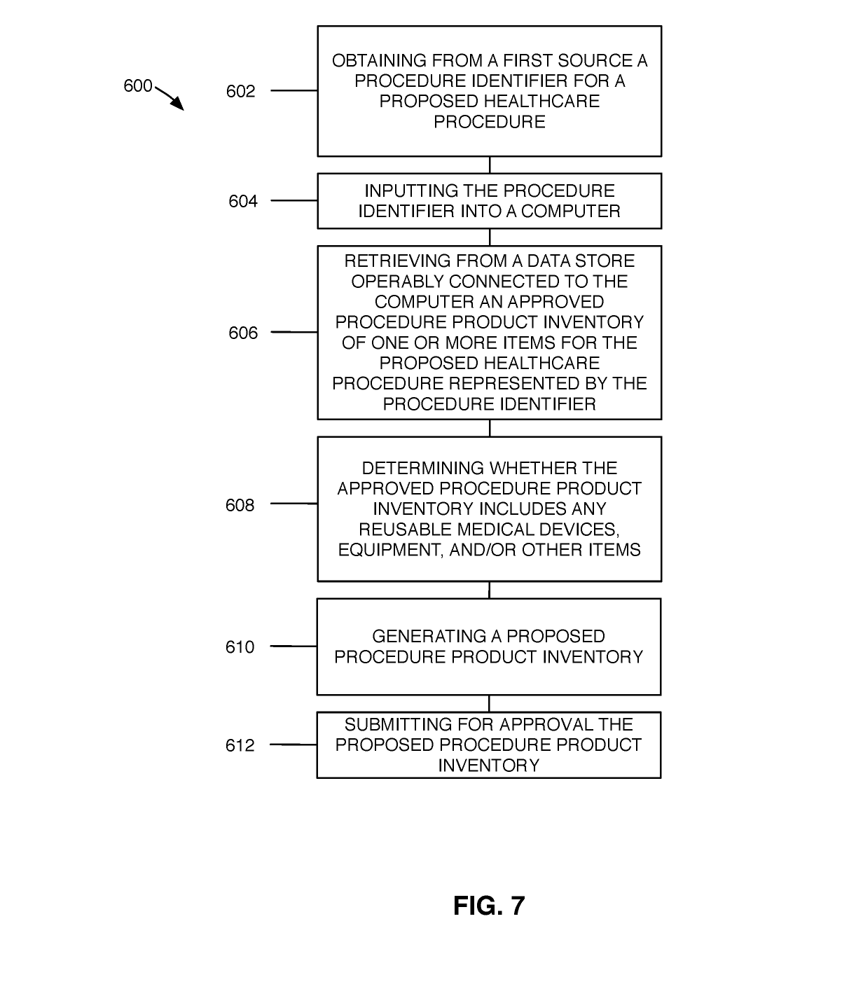

FIG. 7 is a flowchart representation of an example method 600 for auditing proposed healthcare purchases. This method 600 can be used for auditing proposed healthcare purchases. More specifically, this method can be used for auditing proposed healthcare purchases that include one or more components or devices that are reusable. The method 600 can also be used for auditing proposed healthcare purchases that do not include any reusable components or devices. It can also be used for auditing proposed non-healthcare purchases. This method 600 may be performed at any healthcare facility, including a hospital, a nursing home, an outpatient facility, a GPO, and a healthcare clinic. Various functions of the method 600 may be executed on a computer, such as computer 5 described above, in one embodiment. In another embodiment, the method 600 may be executed on a system for auditing proposed healthcare purchases, such as system 100. In other embodiments, the method 300 may be performed on any computer and on any system.

An initial step 602 comprises obtaining from a first source a procedure identifier for a proposed healthcare procedure. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

In this embodiment, the first source comprises a healthcare administrator. However, the first source may comprise any individual employed by, contracted to work for, or acting as a volunteer for a healthcare facility. A skilled artisan will be able to determine a suitable first source according to a particular example based on various considerations, including the organizational structure of the healthcare facility. In another embodiment, the first source may comprise a physician or another healthcare service provider. In an alternative embodiment, the first source may be one or more of a physician or another healthcare service provider and a healthcare administrator, and the person obtaining the procedure identifier may be required to cross-reference the information obtained from one of these individuals with another previously-listed first source. For example, the person obtaining the procedure identifier from a healthcare service provider may need to acquire verification from a healthcare administrator that the correct procedure identifier was obtained, in such an embodiment.

Another step 604 comprises inputting the procedure identifier into a computer. The computer may comprise computer 5, as described above, in this embodiment. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device.

Another step 606 comprises retrieving an approved procedure product inventory comprising one or more items from a data store operably connected to the computer. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is input in step 604, into an appropriate query.

The approved procedure product inventory contains an official list of approved medical devices, equipment, and/or items that are used in a particular surgery or healthcare procedure. It is associated with the procedure identifier that is input in step 604. The approved procedure product inventory may comprise any list of items, including one or more of medical devices, equipment, and/or other items. A skilled artisan will be able to suitably configure the retrieving step according to a particular example based on various considerations, including the configuration of the healthcare facility's computer network. In one embodiment, the data store may be stored on the computer itself. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

The approved procedure product inventory is contained on the data store, described above. The data store contains instructions for use provided by a manufacturer that corresponds to the procedure identifier. The data store is stored on a server and the computer accesses the server via a network to retrieve the approved procedure product inventory from the data store. A skilled artisan will be able to determine how to suitably retrieve the approved procedure product inventory from the data store according to a particular example based on various considerations, including the size of the data store and the configuration of the healthcare facility's computing system. In one embodiment, the data store may be stored on the computer. In a different embodiment, the data store may be stored on a server and the computer may directly access the data store, without the use of a network, to retrieve the approved procedure product inventory from the data store. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 608 comprises determining whether the approved procedure product inventory includes any reusable medical devices, equipment, and/or other items. The approved procedure product inventory may include one or both of reusable and non-reusable medical devices, equipment, and/or other items and may indicate whether a particular medical device, piece of equipment, and/or other item is reusable. Whether a particular medical device, piece of equipment, and/or other item is reusable may be based on regulatory approval information from an organization that regulates the sale of medical devices, such as a government agency that regulates the sale of medical devices. As one example, whether a particular medical device, piece of equipment, and/or other item is reusable may be based on regulatory approval information from the United States Food and Drug Administration (FDA). In various embodiments, any reusable medical devices, equipment, and/or other items may be annotated, highlighted, flagged, and/or otherwise identified.

Another step 610 comprises generating a proposed procedure product inventory. In this embodiment, the proposed procedure product inventory comprises the medical devices, equipment, and/or other items that comprise the approved procedure product inventory, not including any reusable medical devices, equipment, and/or other items that comprise the approved procedure product inventory. Accordingly, in this embodiment, the proposed procedure product inventory contains only non-reusable medical devices, equipment, and/or other items. In this embodiment, step 610 is performed by the computer. A skilled artisan will be able to determine how to suitably generate the proposed procedure product inventory according to a particular example based on various considerations, including the desirability of minimizing the purchase of reusable medical devices, equipment, and/or other items and the particular procedure identifier. In another embodiment, one or more reusable medical devices, equipment, and/or other items may be included on the proposed procedure product inventory. In various embodiments, this step may be performed by any individual, program, or set of individuals, including a healthcare administrator, an attorney, an accountant, any salesperson, and a healthcare service provider. Additionally, step 610 may be performed before or after any of steps 602, 604, 606, and 608.

Another step 612 comprises submitting for approval the proposed procedure product inventory generated in step 610 to a healthcare administrator employed by, contracted to work for, or acting as a volunteer for the healthcare facility. The proposed procedure product inventory may be electronically sent to the healthcare administrator via the Internet, such as through email, through the computer in this embodiment. However, the proposed procedure product inventory may be sent to any person, entity, and/or program and may be sent by any means. A skilled artisan will be able to suitably determine the person and/or entity that will receive the proposed procedure product inventory and the means by which it will be sent according to a particular example based on various considerations, including the corporate structure of the healthcare facility and its communication procedures. In different embodiments, any healthcare administrator may be sent the proposed procedure product inventory, including a device purchaser, executive, accountant, attorney, physician, materials management person, or another healthcare service provider, and device salesperson liaison. In other embodiments, the proposed procedure product inventory may be sent to a healthcare administrator via a fax, an intranet, an internal messaging system, a text message, an alert on his or her respective computer, and by physically printing a copy of the purchase order on the employee's printer. Additionally, the proposed procedure product inventory may be communicated from the computer referenced above to another computer in any manner, including via a network, through a server, and directly from computer to computer in alternate embodiments. Alternatively, a purchase order may be generated, rather than a proposed procedure product inventory.

It is noted that the method 600 may be completed in the order illustrated and described. However, the steps may also be completed in any order.

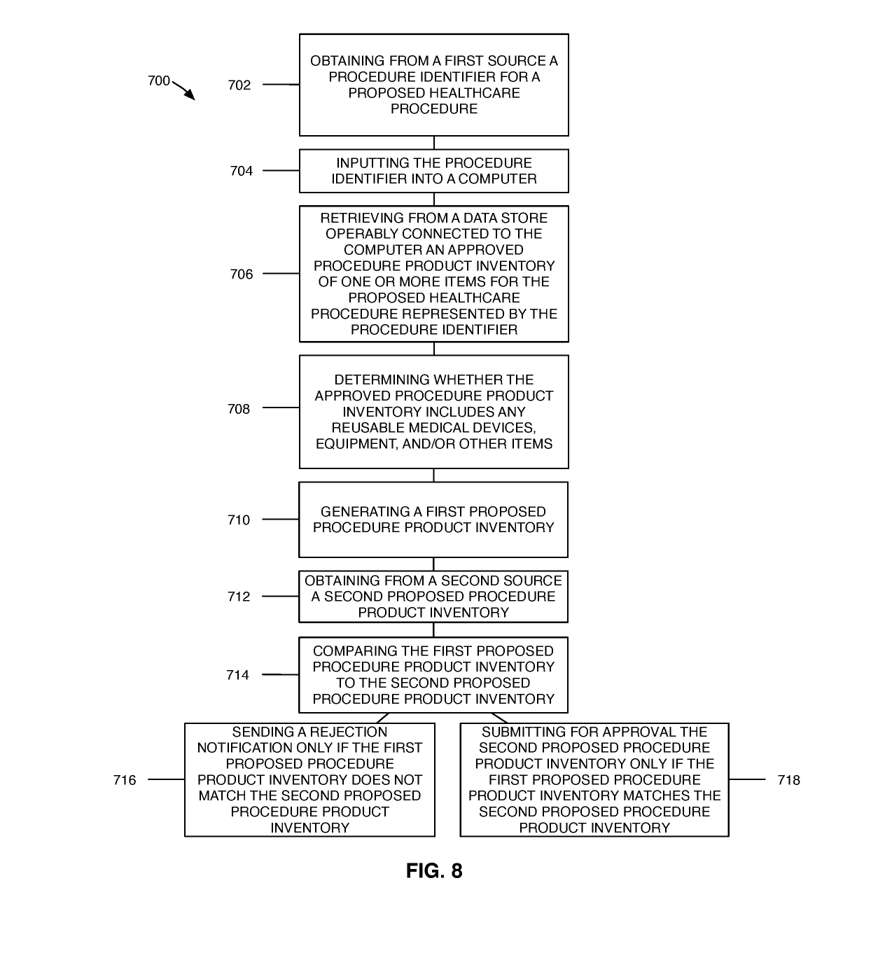

FIG. 8 is a flowchart representation of an example method 700 for auditing proposed healthcare purchases. This method 700 can be used for auditing proposed healthcare purchases. More specifically, this method can be used for auditing proposed healthcare purchases that include one or more components or devices that are reusable. The method 700 can also be used for auditing proposed healthcare purchases that do not include any reusable components or devices. It can also be used for auditing proposed non-healthcare purchases. This method 700 may be performed at any healthcare facility, including a hospital, a nursing home, an outpatient facility, a GPO, and a healthcare clinic. Various functions of the method 700 may be executed on a computer, such as computer 5 described above, in one embodiment. In another embodiment, the method 700 may be executed on a system for auditing proposed healthcare purchases, such as system 100. In other embodiments, the method 700 may be performed on any computer and on any system.

An initial step 702 comprises obtaining from a first source a procedure identifier for a proposed healthcare procedure. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

In this embodiment, the first source comprises a healthcare administrator. However, the first source may comprise any individual employed by, contracted to work for, or acting as a volunteer for a healthcare facility. A skilled artisan will be able to determine a suitable first source according to a particular example based on various considerations, including the organizational structure of the healthcare facility. In another embodiment, the first source may comprise a physician or any another healthcare service provider. In an alternative embodiment, the first source may be one or more of a physician or another healthcare service provider and a healthcare administrator, and the person obtaining the procedure identifier may be required to cross-reference the information obtained from one of these individuals with another previously-listed first source. For example, the person obtaining the procedure identifier from a healthcare service provider may need to acquire verification from a healthcare administrator that the correct procedure identifier was obtained, in such an embodiment.

Another step 704 comprises inputting the procedure identifier into a computer. The computer may comprise computer 5, as described above, in this embodiment. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device.

Another step 706 comprises retrieving an approved procedure product inventory comprising one or more items from a data store operably connected to the computer. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is input in step 704, into an appropriate query.

The approved procedure product inventory contains an official list of approved medical devices, equipment, and/or items that are used in a particular surgery or healthcare procedure. It is associated with the procedure identifier that is input in step 704. The approved procedure product inventory may comprise any list of items, including one or more of medical devices, equipment, and/or other items. A skilled artisan will be able to suitably configure the retrieving step according to a particular example based on various considerations, including the configuration of the healthcare facility's computer network. In one embodiment, the data store may be stored on the computer itself. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

The approved procedure product inventory is contained on the data store, described above. The data store contains instructions for use provided by a manufacturer that corresponds to the procedure identifier. The data store is stored on a server and the computer accesses the server via a network to retrieve the approved procedure product inventory from the data store. A skilled artisan will be able to determine how to suitably retrieve the approved procedure product inventory from the data store according to a particular example based on various considerations, including the size of the data store and the configuration of the healthcare facility's computing system. In one embodiment, the data store may be stored on the computer. In a different embodiment, the data store may be stored on a server and the computer may directly access the data store, without the use of a network, to retrieve the approved procedure product inventory from the data store. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 708 comprises determining whether the approved procedure product inventory includes any reusable medical devices, equipment, and/or other items. The approved procedure product inventory may include one or both of reusable and non-reusable medical devices, equipment, and/or other items and may indicate whether a particular medical device, piece of equipment, and/or other item is reusable. Whether a particular medical device, piece of equipment, and/or other item is reusable may be based on regulatory approval information from an organization that regulates the sale of medical devices, such as a government agency that regulates the sale of medical devices. As one example, whether a particular medical device, piece of equipment, and/or other item is reusable may be based on regulatory approval information from the United States Food and Drug Administration (FDA). In various embodiments, any reusable medical devices, equipment, and/or other items may be annotated, highlighted, flagged, and/or otherwise identified.

Another step 710 comprises generating a first proposed procedure product inventory. In this embodiment, the first proposed procedure product inventory comprises the medical devices, equipment, and/or other items that comprise the approved procedure product inventory, not including any reusable medical devices, equipment, and/or other items included in the approved procedure product inventory. Accordingly, in this embodiment, the first proposed procedure product inventory contains only non-reusable medical devices, equipment, and/or other items. In this embodiment, step 710 is performed by the computer. A skilled artisan will be able to determine how to suitably generate the first proposed procedure product inventory according to a particular example based on various considerations, including the desirability of minimizing the purchase of reusable medical devices, equipment, and/or other items and the particular procedure identifier. In another embodiment, one or more reusable medical devices, equipment, and/or other items may be included on the first proposed procedure product inventory. In such an embodiment, any reusable medical devices, equipment, and/or other items may be annotated, highlighted, flagged, and/or otherwise identified. In various embodiments, this step may be performed by any individual, program, or set of individuals, including a healthcare administrator, an attorney, an accountant, any salesperson, and a healthcare service provider. Additionally, step 710 may be performed before or after any of steps 702, 704, 706, and 708.

Another step 712 comprises obtaining from a second source a second proposed procedure product inventory. A second proposed procedure product inventory is an inventory containing the proposed medical devices, equipment, and/or items that the generator of this inventory believes should be used in a particular surgery or healthcare procedure. The second proposed procedure product inventory may be generated based on the procedure identifier described above.

The second source can be a person or a resource. For example, in this embodiment the second source comprises a medical device and/or equipment salesperson. However, the second source may also comprise any individual employed by, contracted to work for, or acting as a volunteer for a healthcare facility in other embodiments. A skilled artisan will be able to determine a suitable second source according to a particular example based on various considerations, including the organizational structure of the healthcare facility and the whether the healthcare facility requires a salesperson to submit a second proposed procedure product inventory. In another embodiment, the second source may comprise a physician, a materials management person, or another healthcare service provider. In a different embodiment, the second source may comprise a nurse. In other embodiments, the second source may comprise one or more of a book, booklet, logbook, physical or electronic data store, software program, instructions for use document, and a listing of medical devices, equipment, and/or items used in previous procedures having the same procedure identifier. Additionally, in an alternative embodiment, the second source may be one or more of a physician, a materials management person, or another healthcare service provider and a healthcare administrator, and the person obtaining the proposed procedure product inventory may be required to cross-reference the information obtained from one of these individuals with another previously-listed second source. For example, the person obtaining the proposed procedure product inventory from a healthcare administrator may need to acquire verification from a booklet or instructions for use document that the correct proposed procedure product information was obtained. Alternatively, the first source and the second source may comprise the same source.

Another step 714 comprises comparing the first proposed procedure product inventory to the second proposed procedure product inventory. The computer performs this step. This comparison ensures that the first proposed procedure product inventory contains the same devices, equipment, and/or items that are contained in the second proposed procedure product inventory. More specifically, in this embodiment, the comparison ensures that there are no unwanted, as determined by the first proposed procedure product inventory, reusable medical devices, equipment, and/or other items in the second proposed procedure product inventory. Additionally, this step may only be partially performed by the computer. In another embodiment, the server may perform this step and transmit the results of the comparison to a computer, such as computer 5, or any other type of computer.

Another step 716 comprises sending a rejection notification if the first proposed procedure product inventory does not match the second proposed procedure product inventory. The rejection notification is generated by the computer and is displayed to inform the user that the first proposed procedure product inventory includes different data than that required by the second proposed procedure product inventory. The rejection notification can, for example, appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears on the computer. Such another rejection notification may be sent electronically, via the network. It may also be physically printed via a printer that forms a connection with the computer. In another embodiment, the computer may allow for its user to re-input the second proposed procedure product inventory and subsequently perform another comparison of the first proposed procedure product inventory and second proposed procedure product inventory.

Another step 718 comprises submitting for approval the second proposed procedure product inventory to a healthcare administrator employed by, contracted to work for, or acting as a volunteer for the healthcare facility. The second proposed procedure product inventory may be electronically sent to the healthcare administrator via the Internet, such as through email, through the computer in this embodiment. However, the second proposed procedure product inventory may be sent to any person, entity, and/or program and may be sent by any means. A skilled artisan will be able to suitably determine the person and/or entity that will receive the second proposed procedure product inventory and the means by which it will be sent according to a particular example based on various considerations, including the corporate structure of the healthcare facility and its communication procedures. In different embodiments, any healthcare administrator may be sent the second proposed procedure product inventory, including a device purchaser, materials management person, executive, accountant, attorney, physician or another healthcare service provider, and device salesperson liaison. In other embodiments, the second proposed procedure product inventory may be sent to a healthcare administrator via a fax, an intranet, an internal messaging system, a text message, an alert on his or her respective computer, and by physically printing a copy of the purchase order on the employee's printer. Additionally, the second proposed procedure product inventory may be communicated from the computer referenced above to another computer in any manner, including via a network, through a server, and directly from computer to computer in alternate embodiments. Alternatively, a purchase order may be generated, rather than a second proposed procedure product inventory.

It is noted that the method 700 may be completed in the order illustrated and described. However, the steps may also be completed in any order.

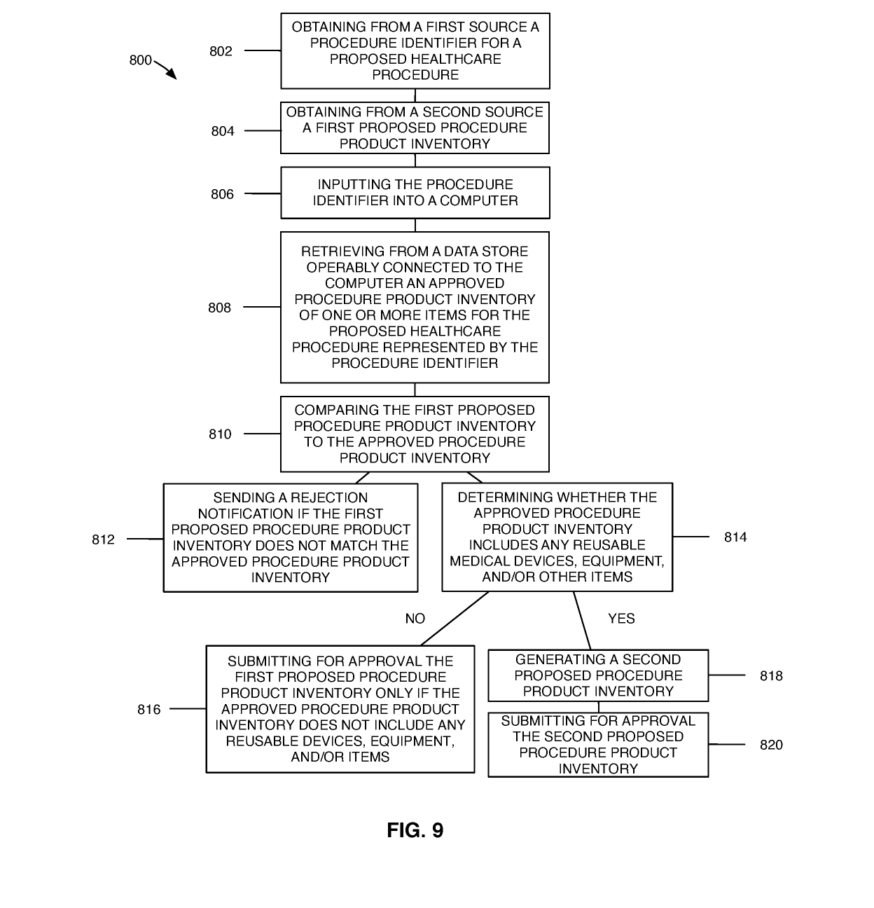

FIG. 9 is a flowchart representation of an example method 800 for auditing proposed healthcare purchases. This method 800 can be used for auditing proposed healthcare purchases. More specifically, this method can be used for auditing proposed healthcare purchases that include one or more components or devices that are reusable. The method 800 can also be used for auditing proposed healthcare purchases that do not include any reusable components or devices. It can also be used for auditing proposed non-healthcare purchases. This method 800 may be performed at any healthcare facility, including a hospital, a nursing home, an outpatient facility, a GPO, and a healthcare clinic. Various functions of the method 800 may be executed on a computer, such as computer 5 described above, in one embodiment. In another embodiment, the method 800 may be executed on a system for auditing proposed healthcare purchases, such as system 100. In other embodiments, the method 800 may be performed on any computer and on any system.

An initial step 802 comprises obtaining from a first source a procedure identifier for a proposed healthcare procedure. A procedure identifier is an identifier generated by a healthcare facility, such as a healthcare facility described above, which corresponds to a particular surgery or healthcare procedure. Procedure identifiers will differ based on the identification system used by various healthcare facilities. In various embodiments, the procedure identifier may comprise any suitable identifier, including a number or set of numbers, a letter or set of letters, any mixture of one or more letters and one or more numbers, alphanumeric strings, one or more symbols or characters, and various combinations thereof. Examples of suitable types of symbols and/or characters include barcodes, QR codes, and the like.

In this embodiment, the first source comprises a healthcare administrator. However, the first source may comprise any individual employed by, contracted to work for, or acting as a volunteer for a healthcare facility. A skilled artisan will be able to determine a suitable first source according to a particular example based on various considerations, including the organizational structure of the healthcare facility. In another embodiment, the first source may comprise a physician or any another healthcare service provider. In an alternative embodiment, the first source may be one or more of a physician or another healthcare service provider and a healthcare administrator, and the person obtaining the procedure identifier may be required to cross-reference the information obtained from one of these individuals with another previously-listed first source. For example, the person obtaining the procedure identifier from a healthcare service provider may need to acquire verification from a healthcare administrator that the correct procedure identifier was obtained, in such an embodiment.

Another step 804 comprises obtaining from a second source a first proposed procedure product inventory. A first proposed procedure product inventory is an inventory containing the proposed medical devices, equipment, and/or items that the generator of this inventory believes should be used in a particular surgery or healthcare procedure. The first proposed procedure product inventory may be generated based on the procedure identifier described above.

The second source can be a person or a resource. For example, in this embodiment the second source comprises a medical device and/or equipment salesperson. However, the second source may also comprise any individual employed by, contracted to work for, or acting as a volunteer for a healthcare facility in other embodiments. A skilled artisan will be able to determine a suitable second source according to a particular example based on various considerations, including the organizational structure of the healthcare facility and the whether the healthcare facility requires a salesperson to submit a first proposed procedure product inventory. In another embodiment, the second source may comprise a physician, a materials management person, or another healthcare service provider. In other embodiments, the second source may comprise one or more of a book, booklet, logbook, physical or electronic data store, software program, instructions for use document, and a listing of medical devices, equipment, and/or items used in previous procedures having the same procedure identifier. Additionally, in an alternative embodiment, the second source may be one or more of a physician, a materials management person, or another healthcare service provider and a healthcare administrator, and the person obtaining the first proposed procedure product inventory may be required to cross-reference the information obtained from one of these individuals with another previously-listed second source. For example, the person obtaining the first proposed procedure product inventory from a healthcare administrator may need to acquire verification from a booklet or instructions for use document that the correct first proposed procedure product inventory was obtained. Alternatively, the first source and the second source may comprise the same source.

Another step 806 comprises inputting the procedure identifier into a computer. The computer may comprise computer 5, as described above, in this embodiment. However, any computer may be used to perform this step. A skilled artisan will be able to select a suitable computer according to a particular example based on various considerations, including the size of the data store and the configuration of the healthcare facility's computing system. In another embodiment, the computer may comprise a mobile device.

Another step 808 comprises retrieving an approved procedure product inventory comprising one or more items from a data store operably connected to the computer. A performer of the method can accomplish this step in any suitable manner, such as by preparing and submitting a query to database server software configured to retrieve the information from the data store. In some embodiments, a performer operates a computer component of a system according to an embodiment that includes software adapted to transform textual input representing the procedure identifier, such as textual input that is input in step 806, into an appropriate query.

The approved procedure product inventory contains an official list of approved medical devices, equipment, and/or items that are used in a particular surgery or healthcare procedure. It is associated with the procedure identifier that is input in step 806. The approved procedure product inventory may comprise any list of items, including one or more of medical devices, equipment, and/or other items. A skilled artisan will be able to suitably configure the retrieving step according to a particular example based on various considerations, including the configuration of the healthcare facility's computer network. In one embodiment, the data store may be stored on the computer itself. In a different embodiment, the query may be based on information other than the procedure identifier, such as the items contained in the proposed procedure identifier. In such an embodiment, the computer may be able to determine which procedure a user is referencing based on the set of items included in the proposed procedure product inventory.

The approved procedure product inventory is contained on the data store, described above. The data store contains instructions for use provided by a manufacturer that corresponds to the procedure identifier. The data store is stored on a server and the computer accesses the server via a network to retrieve the approved procedure product inventory from the data store. A skilled artisan will be able to determine how to suitably retrieve the approved procedure product inventory from the data store according to a particular example based on various considerations, including the size of the data store and the configuration of the healthcare facility's computing system. In one embodiment, the data store may be stored on the computer. In a different embodiment, the data store may be stored on a server and the computer may directly access the data store, without the use of a network, to retrieve the approved procedure product inventory from the data store. In other embodiments, the data store may include approved procedure product inventories from sources other than instructions for use documents provided by manufacturers, including instructions for use documents provided by device salesmen, vendors, and producers. Such approved procedure product inventories may also be added to the data store by hospital administrators, physicians, materials management persons, or another healthcare service providers, and finance administrators in additional embodiments. The approved procedure product inventories may also be acquired from or based on a book, booklet, logbook, physical or electronic data store, software program, U.S. Food and Drug Administration guideline, and a listing of medical devices, equipment, and/or items used in previous procedures having the same procedure identifier in various embodiments.

Another step 810 comprises comparing the first proposed procedure product inventory to the approved procedure product inventory. The computer performs this step. This comparison ensures that the first proposed procedure product inventory contains the same devices, equipment, and/or items contained in the approved procedure product inventory. However, this step may only be partially performed by the computer. In another embodiment, the server may perform this step after receiving a proposed procedure product inventory from the computer, such as computer 5, and transmit the results of the comparison to the computer.

Another step 812 comprises sending a rejection notification if the first proposed procedure product inventory does not match the approved procedure product inventory. The rejection notification is generated by the computer and is displayed to inform the user that the first proposed procedure product inventory includes different data than that required by the approved procedure product inventory. The rejection notification will appear as an error message on the display of the computer. However, a skilled artisan will be able to determine how best to configure sending the rejection notification according to a particular example based on various considerations, including the computer that is used and whom the healthcare facility would like to notify in case of non-matching procedure product inventories. In a different embodiment, another rejection notification may be concurrently sent to a healthcare administrator at the time the rejection notification appears is sent to the user. Such another rejection notification may be sent electronically, via the network. It may also be physically printed via a printer that forms a connection with the computer. In another embodiment, the computer may allow for its user to re-input the first proposed procedure product inventory and subsequently perform another comparison of the first proposed procedure product inventory and approved procedure product inventory.

Another step 814 comprises determining whether the approved procedure product inventory includes any reusable medical devices, equipment, and/or other items. This step may be performed by the computer. The approved procedure product inventory may include one or both of reusable and non-reusable medical devices, equipment, and/or other items and may indicate whether a particular medical device, piece of equipment, and/or other item is reusable. Whether a particular medical device, piece of equipment, and/or other item is reusable may be based on regulatory approval. In this embodiment, step 814 will only occur if the first proposed procedure product inventory matches the approved procedure product inventory. In other embodiments, this step may occur even if the first proposed procedure product inventory does not match the approved procedure product inventory. In another embodiment, the server may perform this step and transmit the results of the comparison to a computer, such as computer 5, or any other type of computer.

Another step 816 comprises submitting for approval the first proposed procedure product inventory to a healthcare administrator employed by, contracted to work for, or acting as a volunteer for the healthcare facility. In this embodiment, this step 816 will occur only if the approved procedure product inventory does not include any reusable devices, equipment, and/or other items. In such an instance, the first proposed procedure product inventory that matches the approved procedure product inventory will be submitted. The first proposed procedure product inventory may be electronically sent to the healthcare administrator via the Internet, such as through email, through the computer in this embodiment. However, the first proposed procedure product inventory may be sent to any person, entity, and/or program and may be sent by any means. A skilled artisan will be able to suitably determine the person and/or entity that will receive the first proposed procedure product inventory and the means by which it will be sent according to a particular example based on various considerations, including the corporate structure of the healthcare facility and its communication procedures. In different embodiments, any healthcare administrator may be sent the first proposed procedure product inventory, including a device purchaser, executive, materials management person, accountant, attorney, physician or another healthcare service provider, and device salesperson liaison. In other embodiments, the first proposed procedure product inventory may be sent to a healthcare administrator via a fax, an intranet, an internal messaging system, a text message, an alert on his or her respective computer, and by physically printing a copy of the purchase order on the employee's printer. Additionally, the first proposed procedure product inventory may be communicated from the computer referenced above to another computer in any manner, including via a network, through a server, and directly from computer to computer in alternate embodiments. Alternatively, a purchase order may be generated, rather than a first proposed procedure product inventory.

Another step 818 comprises generating a second proposed procedure product inventory. In this embodiment, the second proposed procedure product inventory comprises the medical devices, equipment, and/or other items that comprise the approved procedure product inventory, not including any reusable medical devices, equipment, and/or other items that are included in the approved procedure product inventory. Accordingly, in this embodiment, the second proposed procedure product inventory contains only non-reusable medical devices, equipment, and/or other items. In this embodiment, step 818 is performed by the computer. A skilled artisan will be able to determine how to suitably generate the second proposed procedure product inventory according to a particular example based on various considerations, including the desirability of minimizing the purchase of reusable medical devices, equipment, and/or other items and the particular procedure identifier. In another embodiment, one or more reusable medical devices, equipment, and/or other items may be included on the second proposed procedure product inventory. In such an embodiment, any reusable medical devices, equipment, and/or other items may be annotated, highlighted, flagged, and/or otherwise identified. In various embodiments, this step may be performed by any individual, program, or set of individuals, including a healthcare administrator, an attorney, an accountant, any salesperson, and a healthcare service provider.

Another step 820 comprises submitting for approval the second proposed procedure product inventory to a healthcare administrator employed by, contracted to work for, or acting as a volunteer for the healthcare facility. The second proposed procedure product inventory may be electronically sent to the healthcare administrator via the Internet, such as through email, through the computer in this embodiment. However, the second proposed procedure product inventory may be sent to any person, entity, and/or program and may be sent by any means. A skilled artisan will be able to suitably determine the person and/or entity that will receive the second proposed procedure product inventory and the means by which it will be sent according to a particular example based on various considerations, including the corporate structure of the healthcare facility and its communication procedures. In different embodiments, any healthcare administrator may be sent the second proposed procedure product inventory, including a device purchaser, materials management person, executive, accountant, attorney, physician or another healthcare service provider, and device salesperson liaison. In other embodiments, the second proposed procedure product inventory may be sent to a healthcare administrator via a fax, an intranet, an internal messaging system, a text message, an alert on his or her respective computer, and by physically printing a copy of the purchase order on the employee's printer. Additionally, the second proposed procedure product inventory may be communicated from the computer referenced above to another computer in any manner, including via a network, through a server, and directly from computer to computer in alternate embodiments. Alternatively, a purchase order may be generated, rather than a second proposed procedure product inventory.

It is noted that the method 800 may be completed in the order illustrated and described. However, the steps may also be completed in any order.

Those with ordinary skill in the art will appreciate that various modifications and alternatives for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and all equivalents thereof.

We claim:

1. A method for auditing proposed healthcare purchases, comprising the steps of:
obtaining from a first source a procedure identifier for a proposed healthcare procedure;
obtaining from a second source a proposed procedure product inventory;
inputting the procedure identifier into a computer;
retrieving from a data store operably connected to the computer an approved procedure product inventory of one or more items for the proposed healthcare procedure represented by the procedure identifier;
comparing the proposed procedure product inventory to the approved procedure product inventory; and
generating a purchase order for the one or more items of the approved procedure product inventory only if the proposed procedure product inventory matches the approved procedure product inventory.

2. The method of claim 1, further comprising the step of sending the purchase order to a finance administrator.

3. The method of claim 2, further comprising the step of approving the purchase order.

4. The method of claim 3, wherein the approving step is performed by the finance administrator.

5. The method of claim 4, further comprising the step of sending the purchase order to a manufacturer.

6. The method of claim 1, further comprising the step of sending an error notice only if the proposed procedure product inventory does not match the approved procedure product inventory.

7. The method of claim 6, further comprising the step of allowing the proposed procedure product inventory to be edited and re-input into the computer.

8. The method of claim 1, wherein the first source comprises a healthcare service provider.

9. The method of claim 8, wherein the second source comprises a healthcare administrator.

10. The method of claim 1, wherein the data store contains instructions for use provided by a manufacturer that corresponds to the procedure identifier.

11. A method for auditing proposed healthcare purchases, comprising the steps of:
compiling on a computer a data store containing one or more approved procedure product inventories of one or more items for one or more healthcare procedures;
receiving a procedure identifier;
receiving a proposed procedure product inventory;
retrieving from the data store an approved procedure product inventory of one or more items for the healthcare procedure represented by the procedure identifier;
comparing the proposed procedure product inventory to the approved procedure product inventory; and
generating a purchase order for the one or more items of the approved procedure product inventory only if the proposed procedure product inventory matches the approved procedure product inventory.

12. The method of claim 11, further comprising the step of sending the purchase order to a finance administrator.

13. The method of claim 12, further comprising the step of receiving approval of the purchase order.

14. The method of claim 13, further comprising the step of sending the purchase order to a manufacturer.

15. The method of claim 11, further comprising the step of sending an error notice only if the proposed procedure product inventory does not match the approved procedure product inventory.

16. The method of claim 15, further comprising the step of receiving a second proposed procedure product inventory.

17. The method of claim 16, further comprising the step of comparing the second proposed procedure product inventory to the approved procedure product inventory.

18. The method of claim 11, wherein the data store contains an instructions for use provided by a manufacturer that corresponds to the procedure identifier.

19. A system for auditing proposed healthcare purchases, comprising:
a data store configured to store one or more approved procedure product inventories of one or more items for one or more healthcare procedures; and
a computer having a central processing unit and random access memory, the computer operably connected to the data store;
wherein the computer is configured to:
receive a first input;
receive a second input;
retrieve from the data store an approved procedure product inventory of one or more items for the healthcare procedure represented by the first input;
compare the second input to the approved procedure product inventory; and
generate a purchase order for the one or more items of the approved procedure product inventory only if the second input matches the approved procedure product inventory.

20. The system of claim 19, wherein the computer is operably connected to the data store over a network.
